(19) United States
(12) Patent Application Publication
(10) Pub. No.: US 2025/0032354 A1
(43) Pub. Date: Jan. 30, 2025

(54) PERSONAL MASSAGER ASSEMBLY

(71) Applicants: Jason Klarer, Glendale, AZ (US); Raymond Carter, Glendale, AZ (US)

(72) Inventors: Jason Klarer, Glendale, AZ (US); Raymond Carter, Glendale, AZ (US)

(21) Appl. No.: 18/439,894

(22) Filed: Feb. 13, 2024

(51) Int. Cl. A61H 23/02

(52) U.S. Cl. CPC A61H 23/0254; A61H 2201/0153; A61H 2201/0207; A61H 2205/062

(57) ABSTRACT

A personal massager assembly for facilitating a user to massage the user's own shoulders includes a handle which is elongated between a first end and a second end and comprises a shoulder portion which is shaped and configured to extend around the shoulder of the user. A controller module with a vibration motor is selectively mountable to the second end of the handle, and a massager head is selectively mountable to the controller module such that the vibration motor is operable to vibrate the massager head. In some embodiments, multiple massager heads may be interchangeably mountable to the controller module or a massager mount that does not have another vibration motor. A heater massager may be configured to mount to the controller module and be caused to heat by the controller module. An auxiliary grip may attach to the handle or interchangeably to any of the massager heads.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to personal massagers and more particularly pertains to a new personal massager for facilitating a user to massage the user's own shoulders and other areas of the user that may be difficult to reach.

### (2) Description of Related Art Including Information Disclosed Under 37 CFR 1.97 and 1.100

Various personal massagers are available which use an elongated handle that is curved or otherwise shaped to allow a user to hold the elongated handle generally in front of the user while massaging the user's shoulder or back. However, the prior art fails to describe such a device with several useful and novel features, including a variety of interchangeable massager heads that interchangeably mount to the handle via either a controller module that vibrates or heats a selected massager head or a massager mount that does not vibrate or heat the selected massager head. Additionally, the prior art does not disclose an auxiliary grip which may selectively attach to the handle for improved grip of the handle or to the selected massager head to provide a more compact form for the device

### BRIEF SUMMARY OF THE INVENTION

An embodiment of the disclosure meets the needs presented above by generally comprising a handle which is elongated between a first end and a second end. The handle comprises a shoulder portion at the second end which is shaped and configured to extend around a shoulder of a user. A controller module is selectively mountable to the second end of the handle and comprises a housing, a processor mounted in the housing, and a vibration motor mounted in the housing and operably coupled to the processor. A massager head is selectively mountable to the controller module. The massager head comprises a base, an engagement member, and a connector. The base is coupled to and extends between the engagement member and the connector. The connector is shaped to insert into a vibration massager-receiving opening defined by the housing of the controller module to mount the vibration massager to the controller module and operably engage the vibration motor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a personal massager assembly according to an embodiment of the disclosure. A controller module of the assembly is depicted attached to a handle and one of a plurality of massager heads of the assembly. An auxiliary grip is also depicted attached to the handle.

FIG. 2 is an exploded perspective view of an embodiment of the disclosure as arranged in FIG. 1.

FIG. 3 is a side view of an embodiment of the disclosure as arranged in FIG. 1.

FIG. 4 is a detail side view of an embodiment of the disclosure as arranged in FIG. 1. The massager head attached to the controller module in FIGS. 1-4 is a vibration massager which engages the vibration motor of the controller module.

FIG. 5 is a detail side view of an embodiment of the disclosure similar to FIG. 4. However, a heater massager is mounted to the controller module instead of the vibration massager.

FIG. 6 is a perspective view of an embodiment of the disclosure with a controller module mounted to an auxiliary grip and a massager head.

FIG. 7 is an exploded view of an embodiment of the disclosure as arranged in FIG. 6.

FIG. 8 is an exploded perspective view of a plurality of vibration massagers and a controller module of an embodiment of the disclosure.

FIG. 9 is an exploded perspective view of a heater massager and a controller module of an embodiment of the disclosure.

FIG. 10 is an exploded perspective view of a cold massager and a massager mount of an embodiment of the disclosure.

FIG. 11 is an in-use view of an embodiment of the disclosure.

### DETAILED DESCRIPTION OF THE INVENTION

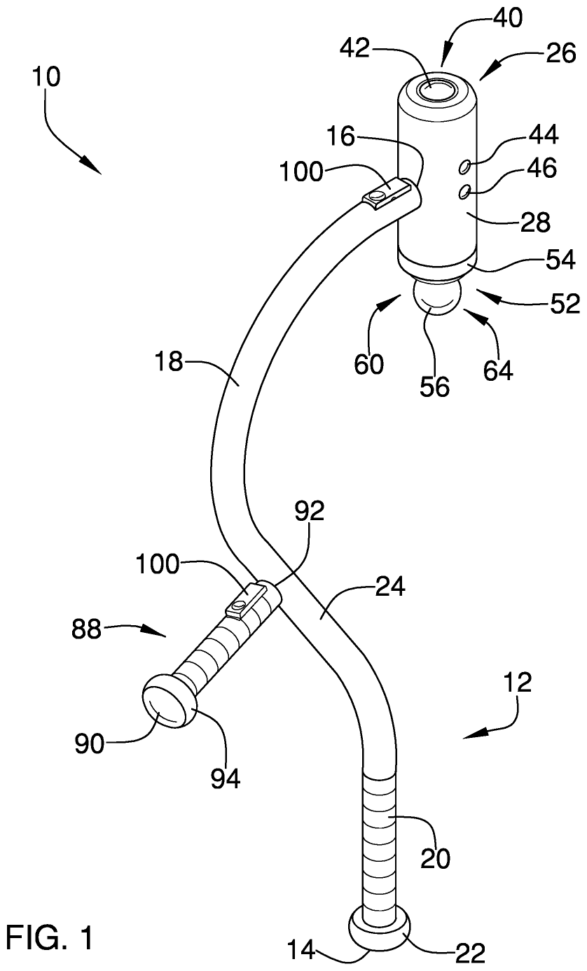

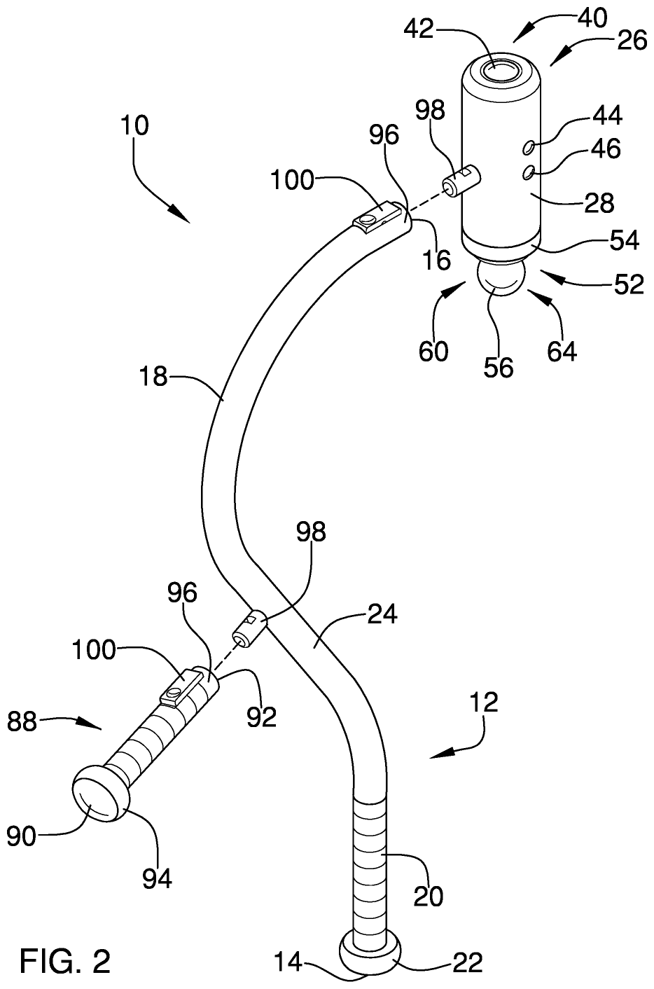

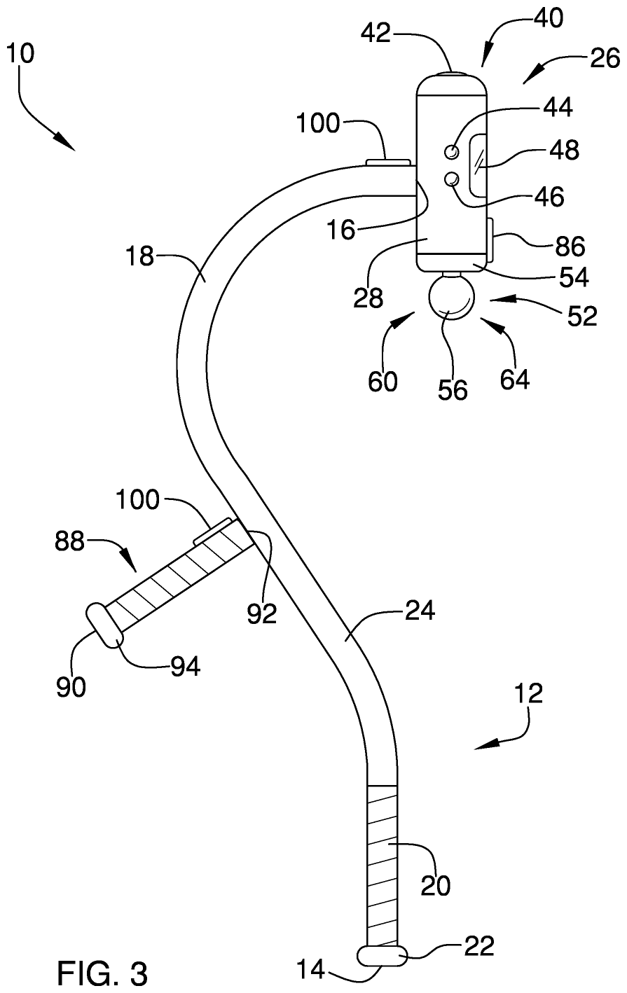

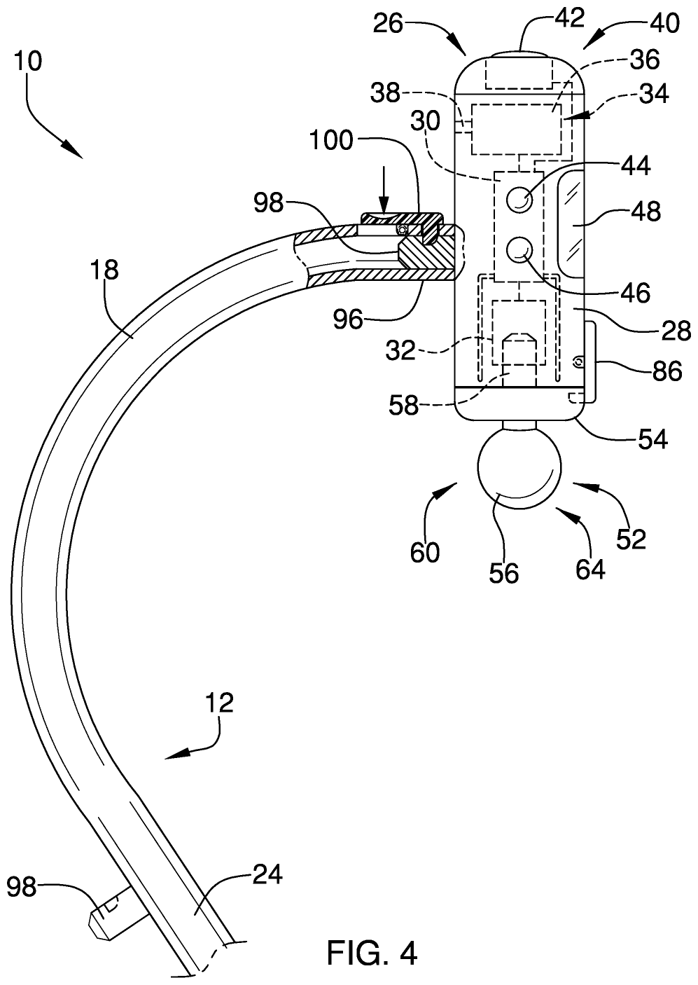

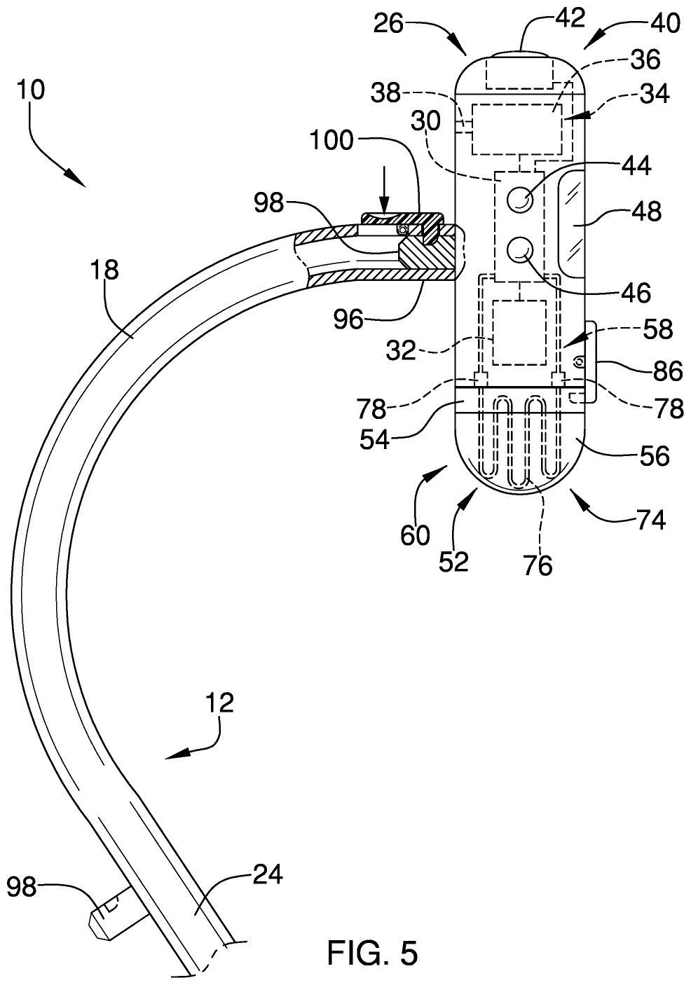

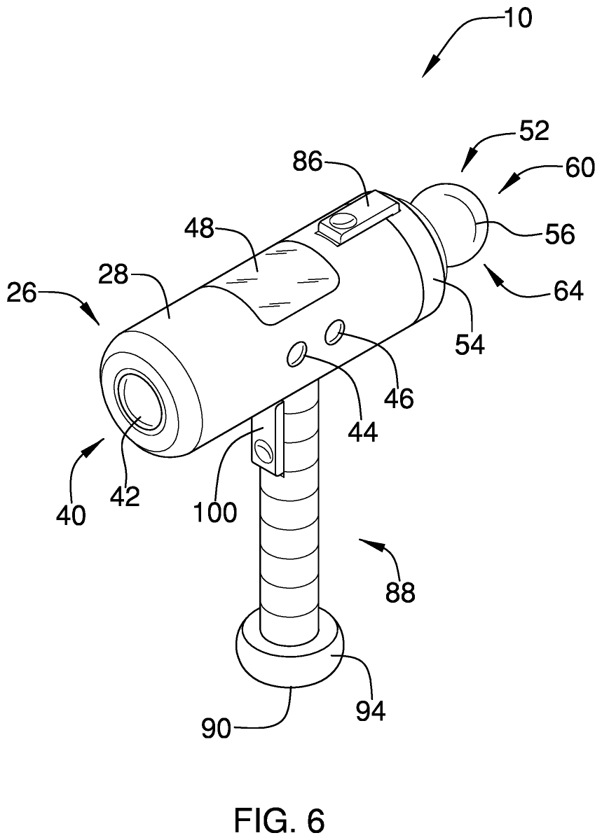

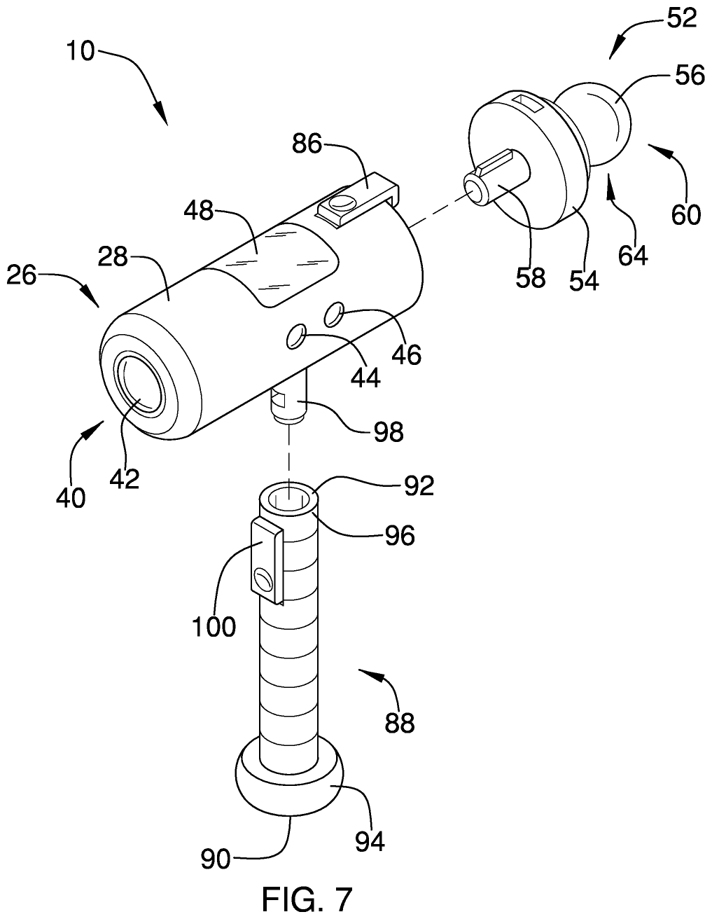

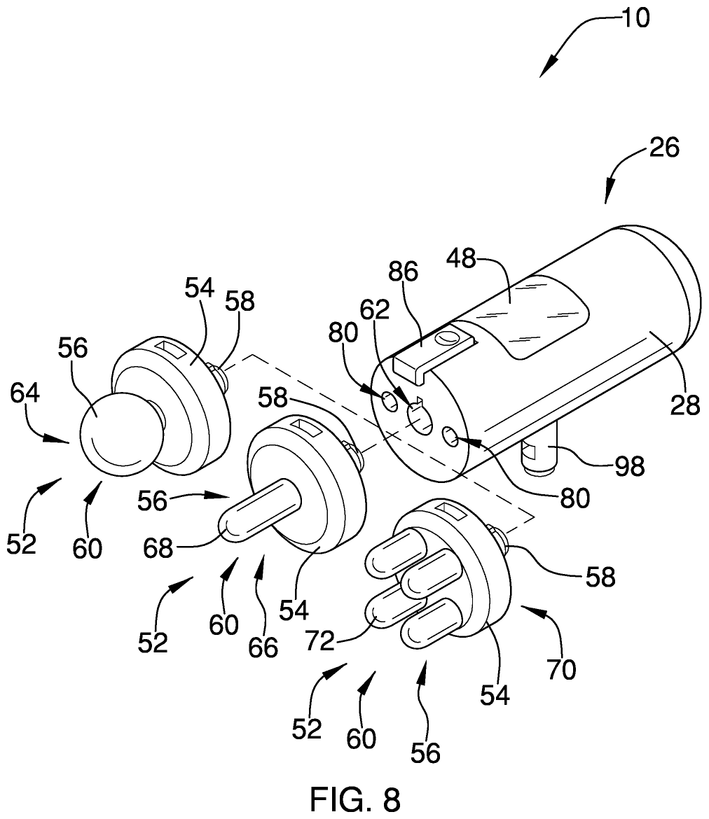

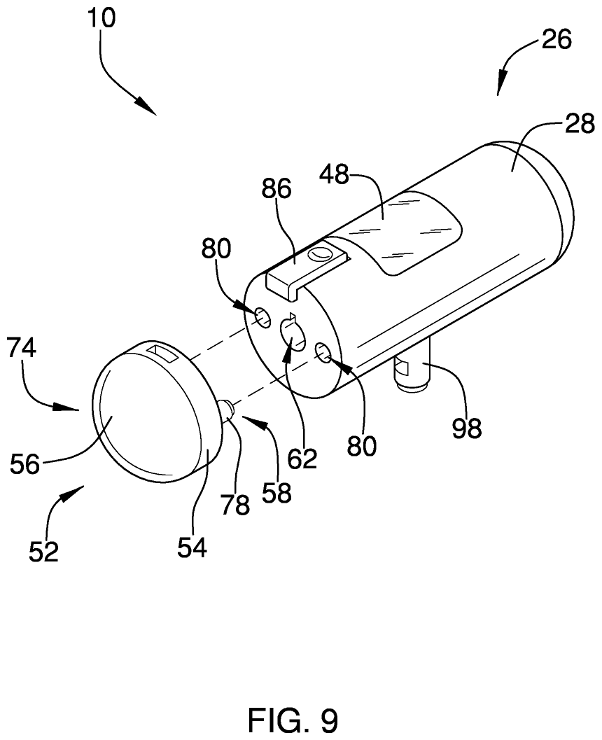

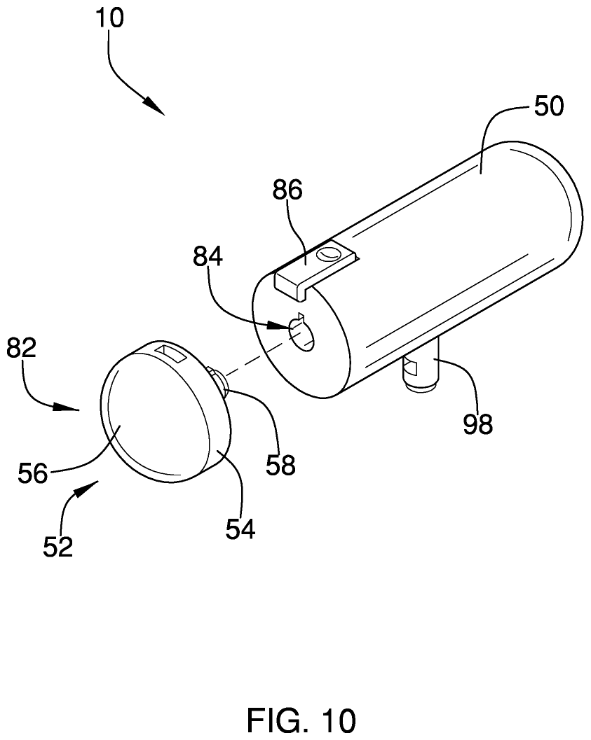

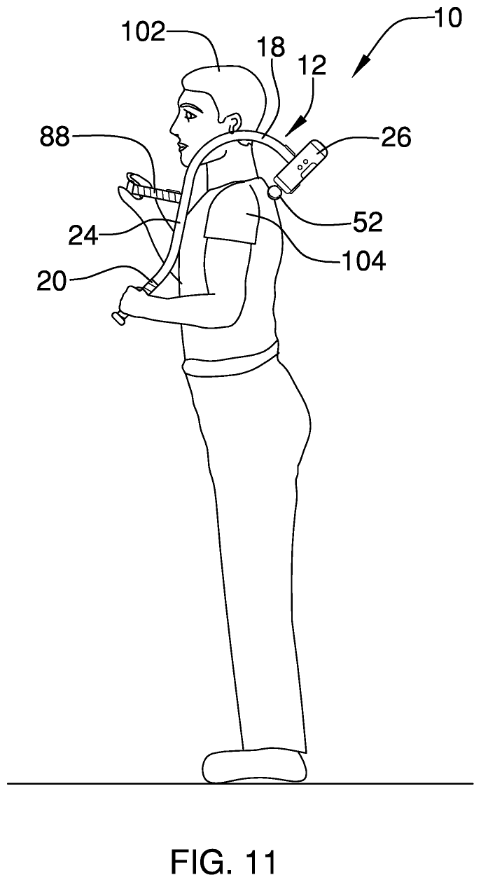

With reference now to the drawings, and in particular to FIGS. 1 through 11 thereof, a new personal massager embodying the principles and concepts of an embodiment of the disclosure and generally designated by the reference numeral 10 will be described.

As best illustrated in FIGS. 1 through 11, the personal massager assembly 10 generally comprises a handle 12 which is elongated between a first end 14 and a second end 16. The handle 12 comprises a shoulder portion 18 at the second end 16 which is shaped and configured to extend around a shoulder 104 of a user 102. The shoulder portion 18 is arcuately shaped but may have other shapes, including for example having multiple linear segments arranged to extend around the shoulder 104. The handle 12 comprises a grasping portion 20 at the first end 14 which is straight. The grasping portion 20 has a handle knob 22 at the first end 14 and is frictionally enhanced. The grasping portion 20 may comprise a frictionally enhanced material such as rubber or silicone, a frictionally enhanced surface texture, or the like. The handle 12 also comprises an intermediate portion 24 which extends from the grasping portion 20 to the shoulder portion 18. The intermediate portion 24 is straight and is angled away from a central axis of the grasping portion 20 to form an obtuse angle with the grasping portion 20. The shoulder portion 18 curves away from the intermediate portion 24 toward the central axis of the grasping portion 20. In this manner, the handle 12 defines a substantially question mark shaped path.

A controller module 26 and a massager mount 50 are selectively and interchangeably mountable to the second end 16 of the handle 12. A plurality of massager heads 52 are provided, each of which is interchangeably mountable to at least one of the controller module 26 and the massager mount 50. The controller module 26 comprises a housing 28, a processor 30, and a vibration motor 32. The processor 30 is mounted in the housing 28 and the vibration motor 32 is mounted in the housing 28 and is operably coupled to the processor 30. A power supply 34 is mounted in the housing 28 and is electrically coupled to the processor 30. The power supply 34 comprises a battery 36 but may comprise a capacitor or any suitable power storage. A charging port 38 is mounted on the housing 28 and is electrically coupled to the power supply 34.

A user interface 40 is mounted to the housing 28 and is operatively coupled to the processor 30. A display 48 is mounted on the housing 28 and is operatively coupled to the processor 30 and may be configured to present operational data for the processor 30. The user interface 40 comprises a power button 42 for selectively activating the processor 30, a heat button 44 for operating the processor 30 to heat the heater massager, and a vibration button 46 for operating the vibration motor 32. The power button 42 is positioned on a rear side of the housing 28 of the controller module 26 opposite where the massager heads 52 are mounted, and the heat button 44 and the vibration button 46 are positioned on a side surface of the housing 28. Other arrangements are possible for the user interface 40. For example, the user interface 40 and the display 48 may be integrated into a touchscreen.

Each massager head 52 comprises a base 54, an engagement member 56, and a connector 58. The base 54 is coupled to and extends between the engagement member 56 and the connector 58. The plurality of massager heads 52 includes a set of vibration massagers 60, a heater massager 74, and a cold massager 82. The connector 58 of each vibration massager 60 is shaped to insert into a vibration massager-receiving portion opening 62 defined by the housing 28 of the controller module 26 to mount the vibration massager 60 to the controller module 26 and operably engage the vibration motor 32. The set of vibration massagers 60 includes a ball massager 64, a single-pronged massager 66, and a multiple-pronged massager 70. The engagement member 56 of the ball massager 64 is spherically shaped, the engagement member 56 of the single-pronged massager 66 comprises a single elongated prong 68, and the engagement member 56 of the multiple-pronged massager 70 comprises a plurality of elongated prongs 72.

The heater massager 74 comprises a heating element 76 mounted in the engagement member 56. The connectors 58 of the heater massagers 74 define a pair of electrical contacts 78 in electrical communication with the heating element 76. The electrical contacts 78 are shaped to insert into a pair of electrical massager-receiving openings 80 defined by the housing 28 of the controller module 26 to mount the heater massager 74 to the controller module 26 and electrically couple the heating element 76 to the processor 30. The processor 30 is programmed to selectively send electrical power through the heating element 76 of the heater massager 74 via the electrical contacts 78.

The connector 58 of the cold massager 82 is shaped to insert into a stationary massager opening 84 of the massager mount 50 to mount the cold massager 82 to the massager mount 50. The cold massager 82 may comprise a thermal mass material with a heat capacity sufficient to remain below a desired temperature during use. The cold massager 82 may also be removably attachable to the controller module 26 in some embodiments. The heater massager 74 and the vibration massagers 60 may also be removably attachable to the massager mount 50 in some embodiments. Retaining latches 86 are attached to the controller module 26 and the massager mount 50 respectively and are operable to retain a selected massager head 52 to the respective one of the controller module 26 and the massager mount 50.

An auxiliary grip 88 is interchangeably mountable to the handle 12, the controller module 26, and the massager mount 50. The auxiliary grip 88 is elongated between a base end 90 and an attachment end 92. The auxiliary grip 88 is frictionally enhanced via a frictionally enhanced material such as rubber or silicone or a frictionally enhanced texture. The auxiliary grip 88 also has a grip knob 94 at the base end 90. The attachment end 92 of the auxiliary grip 88 is mountable to the handle 12 at the intermediate portion 24. The attachment end 92 is also interchangeably mountable to the controller module 26 and the massager mount 50. The attachment end 92 of the auxiliary grip 88 and the second end 16 of the handle 12 have receivers 94 which are complementary in shape and size and which interchangeably receive insertion members 98 attached to the controller module 26 and the massager mount 50. An additional insertion member 98 is attached to the intermediate portion 24 of the handle 12 which is shaped to insert into the receiver 96 of the auxiliary grip 88. Accessory latches 100 are mounted to the auxiliary grip 88 and the handle 12 and are operable to secure the auxiliary grip 88 to the handle 12 or either of the auxiliary grip 88 or the handle 12 to the controller module 26 or the massager mount 50.

In use, a selected one of the massager heads 52 may be mounted to a selected one of the controller module 26 and the massager mount 50 as described above. Then the controller module 26 or the massager mount 50 may be mounted to the handle 12 or the auxiliary grip 88, which may then be grasped by the user 102 and used to urge the selected massager head 52 against the user's 102 body to massage the user 102. If the controller module 26 or the massager mount 50 is mounted to the handle 12, the auxiliary grip 88 may also be mounted to the handle 12 so that the user 102 may grasp two spaced apart portions of the assembly 10. The vibration massagers 60 may be caused to vibrate via operation of the vibration motor 32 to vibrate treatment areas on the user 102. The heater massager 74 may be caused to heat via operation of the processor 30 to heat the treatment areas. The cold massager 82 may be used to cool the treatment areas by cooling the cold massager 82 prior to use, such as by storing the cold massager 82 in a freezer or the like. The display 48 may present menus indicating selections for various heat settings, vibration settings, and the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A personal massager assembly comprising:
a handle being elongated between a first end and a second end, the handle comprising a shoulder portion at the second end which is shaped and configured to extend around a shoulder of a user;
a controller module being selectively mountable to the second end of the handle,
the controller module comprising:
a housing;
a processor mounted in the housing; and
a vibration motor mounted in the housing and operably coupled to the processor; and
a massager head selectively mountable to the controller module, the massager head comprising a base, an engagement member, and a connector, the base being coupled to and extending between the engagement member and the connector, the connector being shaped to insert into a vibration massager-receiving opening defined by the housing of the controller module to mount the vibration massager to the controller module and operably engage the vibration motor.

2. The assembly of claim 1, wherein the handle comprises a grasping portion at the first end, the grasping portion being straight.

3. The assembly of claim 2, wherein the grasping portion has a handle knob at the first end, the grasping portion being frictionally enhanced.

4. The assembly of claim 2, wherein the handle comprises an intermediate portion which extends from the grasping portion to the shoulder portion, the intermediate portion being straight, the intermediate portion being angled away from a central axis of the grasping portion to form an obtuse angle with the grasping portion, the shoulder portion curving away from the intermediate portion toward the central axis of the grasping portion.

5. The assembly of claim 1, wherein the massager head is one of a plurality of massager heads, each massager head being selectively and interchangeably mountable to the controller module, each massager head comprising a base, an engagement member, and a connector, the base being coupled to and extending between the engagement member and the connector.

6. The assembly of claim 5, wherein the plurality of massager heads includes a set of vibration massagers, the connector of each vibration massager being shaped to insert into a vibration massager-receiving opening defined by the housing of the controller module to mount the vibration massager to the controller module and operably engage the vibration motor.

7. The assembly of claim 6, wherein the set of vibration massagers includes a ball massager, the engagement member of the ball massager being spherically shaped.

8. The assembly of claim 6, wherein the set of vibration massagers includes a single-pronged massager, the engagement member of the single-pronged massager comprising a single elongated prong.

9. The assembly of claim 6, wherein the set of vibration massagers includes a multiple-pronged massager, the engagement member of the multiple-pronged massager comprising a plurality of elongated prongs.

10. The assembly of claim 5, wherein the plurality of massager heads includes a heater massager comprising a heating element mounted in the engagement member, the connector of the heater massager comprising a pair of electrical contacts in electrical communication with the heating element, the pair of electrical contacts being shaped to insert into a pair of electrical massager-receiving openings defined by the housing of the controller module to mount the heater massager to the controller module and electrically couple to the processor, the processor being programmed to selectively send electrical power through the heating element of the heater massager via the electrical contacts.

11. The assembly of claim 1, further comprising:
a massager mount being selectively mountable to the second end of the handle, the controller module and the massager mount being interchangeably mountable to the second end of the handle;
wherein the massager head is one of a plurality of massager heads, each massager head being selectively and interchangeably mountable to the controller module, each massager head comprising a base, an engagement member, and a connector, the base being coupled to and extending between the engagement member and the connector, the plurality of massager heads including:
a vibration massager, the connector of the vibration massager being shaped to insert into a vibration massager-receiving opening defined by the housing of the controller module to mount the vibration massager to the controller module and operably engage the vibration motor; and
a cold massager, the connector of the cold massager being shaped to insert into a stationary massager opening of the massager mount to mount the cold massager to the massager mount.

12. The assembly of claim 1, wherein the controller module further comprises a power supply mounted in the housing and electrically coupled to the processor.

13. The assembly of claim 12, wherein the power supply comprises a battery.

14. The assembly of claim 12, wherein the controller module further comprises a charging port mounted on the housing and electrically coupled to the power supply.

15. The assembly of claim 1, wherein the controller module further comprises a user interface mounted to the housing and operatively coupled to the processor.

16. The assembly of claim 1, wherein the controller module further comprises a display mounted on the housing and operatively coupled to the processor.

17. The assembly of claim 1, further comprising an auxiliary grip being interchangeably mountable to the handle and the controller module.

18. The assembly of claim 17, wherein the auxiliary grip is elongated between a base end and an attachment end, the attachment end of the auxiliary grip being mountable to the handle at the intermediate portion.

19. The assembly of claim 17, wherein the auxiliary grip is frictionally enhanced, the auxiliary grip having a grip knob at the base end.

20. A personal massager assembly comprising:
a handle being elongated between a first end and a second end, the handle comprising a shoulder portion at the second end which is shaped and configured to extend around a shoulder of a user, the shoulder portion being arcuately shaped, the handle comprising a grasping portion at the first end, the grasping portion being straight, the grasping portion having a handle knob at the first end, the grasping portion being frictionally enhanced, the handle comprising an intermediate portion which extends from the grasping portion to the shoulder portion, the intermediate portion being straight, the intermediate portion being angled away from a central axis of the grasping portion to form an obtuse angle with the grasping portion, the shoulder portion curving away from the intermediate portion toward the central axis of the grasping portion;
a controller module being selectively mountable to the second end of the handle,
the controller module comprising:
a housing;
a processor mounted in the housing;
a vibration motor mounted in the housing and operably coupled to the processor;
a power supply mounted in the housing and electrically coupled to the processor, the power supply comprising a battery;
a charging port mounted on the housing and electrically coupled to the power supply;
a user interface mounted to the housing and operatively coupled to the processor; and
a display mounted on the housing and operatively coupled to the processor;
a massager mount being selectively mountable to the second end of the handle, the controller module and the massager mount being interchangeably mountable to the second end of the handle;
a plurality of massager heads, each massager head being selectively and interchangeably mountable to at least one of the controller module and the massager mount, each massager head comprising a base, an engagement member, and a connector, the base being coupled to and extending between the engagement member and the connector, the plurality of massager heads including:
a set of vibration massagers, the connector of each vibration massager being shaped to insert into a vibration massager-receiving opening defined by the housing of the controller module to mount the vibration massager to the controller module and operably engage the vibration motor, the set of vibration massagers including:
a ball massager, the engagement member of the ball massager being spherically shaped;
a single-pronged massager, the engagement member of the single-pronged massager comprising a single elongated prong; and
a multiple-pronged massager, the engagement member of the multiple-pronged massager comprising a plurality of elongated prongs;
a heater massager comprising a heating element mounted in the engagement member, the connector of the heater massager comprising a pair of electrical contacts in electrical communication with the heating element, the pair of electrical contacts being shaped to insert into a pair of electrical massager-receiving openings defined by the housing of the controller module to mount the heater massager to the controller module and electrically couple to the processor, the processor being programmed to selectively send electrical power through the heating element of the heater massager via the electrical contacts; and
a cold massager, the connector of the cold massager being shaped to insert into a stationary massager opening of the massager mount to mount the cold massager to the massager mount; and
an auxiliary grip being interchangeably mountable to the handle, the controller module, and the massager mount, the auxiliary grip being elongated between a base end and an attachment end, the attachment end of the auxiliary grip being mountable to the handle at the intermediate portion, the auxiliary grip being frictionally enhanced, the auxiliary grip having a grip knob at the base end.
